(19) United States
(12) Patent Application Publication
(10) Pub. No.: US 2010/0109341 A1
(43) Pub. Date: May 6, 2010

(54) System and method for generating power using angular kinetic energy

(75) Inventor: Larry W. Fullerton, New Hope, AL (US)

Correspondence Address: Mark D. Roberts, 416 Zandale Drive, Huntsville, AL, 35801, US

(73) Assignee: Cedar Ridge Research LLC, New Hope, AL (US)

(21) Appl. No.: 12/590,076

(22) Filed: Nov. 2, 2009

Related U.S. Application Data
(60) Provisional application No. 61/198,506, filed on Nov. 6, 2008.

(51) Int. Cl. H02K 7/18; G01C 19/00

(52) U.S. Cl. 290/1 R; 74/5 R

(57) ABSTRACT

A system and method for generating power using angular kinetic energy is provided. A gyroscope power generator is positioned at a location on a spinning astronomical body and oriented based upon the location so as to couple the angular kinetic energy of the spinning astronomical body through the gyroscope power generator to a load. An energy source is provided to the gyroscope power generator to achieve a gyroscopic moment sufficient to couple to the spin rate of the spinning astronomical body. The energy source is removed and power produced by the gyroscope power generator is harnessed.

### CROSS-REFERENCE TO RELATED APPLICATIONS

This non-provisional application claims the benefit of U.S. Provisional Application Ser. No. 61/198,506, filed Nov. 6, 2008, titled “A System and Method for Generating Power Using Angular Kinetic Energy”, which is incorporated by reference herein in its entirety.

### FIELD OF THE INVENTION

The present invention relates generally to a system and method for generating power using angular kinetic energy. More particularly, the present invention relates to a system and method for harnessing energy by coupling the angular kinetic energy of a spinning mass to a load.

### BACKGROUND OF THE INVENTION

According to Wikipedia, the free encyclopedia, a gyroscopic exercise tool is a device used to exercise the wrist as part of physical therapy or in order to build hand and finger strength. It can also be used to demonstrate certain aspects of rotational dynamics. The device consists of a tennis ball-sized plastic or metal shell around a free-spinning mass, which can be started with a short rip string or by a snap of the thumb. Once the gyroscope inside is going fast enough, a person holding the device can accelerate the spinning mass to high revolution rates by moving the wrist in a circular motion.

The device essentially consists of a spinning mass inside an outer shell. The shell almost completely covers the mass inside, with only a small round opening allowing the gyroscope to be manually started. The spinning mass is fixed to a thin metal axle, each end of which is trapped in a circular, equatorial groove in the outer shell. A lightweight ring with two notches in it for the ends of the axle rests in the groove. This ring can slip in the groove; it holds the spinning gyroscope centered in the shell, preventing the two from coming into contact, but still allowing the orientation of the axle to change. Once the gyroscope is spinning, tipping the device causes the gyroscope to precess, with its axle slipping around in the groove in a circular fashion. The groove inside the device is a little wider than the axle; an externally applied torque causes one end of the axle to push against the upper rim of the groove, while the other end pushes against the lower rim of the groove. These two effects combine to make the device work: as the gyroscope precesses in response to an external torque, one end of the axle “rolls” along the top edge of the groove while the other end “rolls” along the bottom edge, speeding up the rotation of the spinning mass.

The acceleration of the gyroscope is best when the precession of the gyroscope is followed by wrist motion, so that an accelerating torque is continually applied.

Names under which gyroscopic exercise tools are sold include DynaBee and Powerball. DynaBee has been a brand name since the 1970s for gyroscopic wrist exercisers. Recent versions of such devices include features such as revolution counters and gyro-powered LED lights, where light-emitting diodes are powered by a small generator that harnesses the energy of the mass spinning inside the gyroscopic exercise tool.

U.S. Pat. Nos. 5,150,625, 5,353,655, 5,800,311, and 6,623,405 disclose versions of gyroscopic exercise tools that include power generation functionality. These patents are incorporated by reference herein in their entirety. FIGS. 1A through 1B depict various examples of power generation approaches described in U.S. Pat. Nos. 5,150,625 and 5,353,655. FIG. 2 depicts a power generation approach described in U.S. Pat. Nos. 5,800,311 and 6,623,405.

The worldwide requirements for power grow substantially each year. It is therefore desirable to have an improved system and method for generating power using angular kinetic energy.

### SUMMARY OF THE INVENTION

Briefly, the present invention is an improved system and method for generating power using angular kinetic energy. The invention includes a method for generating power using angular kinetic energy having the steps of positioning a gyroscope power generator at a location on a spinning body, orienting the gyroscope power generator so as to couple the angular kinetic energy of the spinning body through said gyroscope power generator to a load, providing an energy source to the gyroscope power generator to achieve a gyroscopic moment sufficient to couple to the spin rate of the spinning body, removing the energy source, and harnessing power produced by the gyroscope power generator.

The spinning body can be a planet such as the Earth, a moon, an asteroid, a satellite, a spacecraft, or a space station.

The gyroscope power generator may be oriented based on a location of the gyroscope power generator on the spinning body. More specifically, the gyroscope power generator may be oriented based on a latitude or a elevation of the gyroscope power generator on the spinning body

The invention includes a gyroscope power generator for generating power using angular kinetic energy including an equatorial mount having a first axis positioned relative to an equatorial axis of a spinning body and having

a rotational element that can rotate along a second axis. The gyroscope power generator also includes a gyroscope positioned to pivot about a top axis having a desired angle relative to the equatorial axis. The gyroscope includes a rotor and at least one power generation element to generate power based on the spinning of the rotor, where the at least one power generation element is one of a coil or a magnet. The gyroscope power generator also includes a power storage device for storing the power generated by the at least one power generation element.

The desired angle may be determined based on a location of the gyroscope power generator on the spinning body. The location may correspond to a latitude of the gyroscope power generator and/or the elevation of the gyroscope power generator.

The gyroscope power generator may be combined with at least one conventional power source such as an electrical power source, a gas power source, a hydro power source, a wind power source, or a solar power source.

The equatorial mount may be one of a German equatorial mount, a Fork equatorial mount, an English equatorial mount, or a Horseshoe equatorial mount.

The second axis may be perpendicular to the first axis.

The invention also includes a method for generating power, comprising the steps of coupling the angular kinetic energy of a spinning body through a gyroscope power generator to a load and achieving a gyroscopic moment sufficient to couple to the spin rate of the spinning body such that the gyroscope power generator and the spinning body generate power.

The spinning body may be one of a planet, a moon, an asteroid, a satellite, a spacecraft, or a space station.

The gyroscope power generator may be oriented based on a location of the gyroscope power generator on the spinning body.

The gyroscope power generator may be oriented based on a latitude of the location of the gyroscope power generator.

The gyroscope power generator may be oriented based on an elevation of the location of the gyroscope power generator.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A is a sectional view of a gyroscopic device illustrating means associated with such a device for generating electricity;

FIGS. 1B and 1C provide different cross-sectional views of a gyroscopic device illustrating a second form of electrical generating means that can be associated with such a device;

FIG. 2 provides a perspective view of a gyroscopic device illustrating a third form of electrical generating means that can be associated with such a device;

FIG. 3 depicts the components of an exemplary gyroscope;

FIG. 4 depicts precession of the exemplary gyroscope;

FIG. 5 depicts precession of the Earth;

FIG. 6 depicts exemplary equatorial mounts;

FIG. 7 depicts an exemplary system in accordance with the present invention;

FIG. 8 depicts an exemplary gyroscopic power system having an exemplary configuration based on its location on the Earth; and

FIG. 9 depicts an exemplary method in accordance with the present invention.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

The present invention provides an improved system and method for generating power using angular kinetic energy of a spinning astronomical body, for example, the Earth, a moon, or an asteroid. Specifically, the present invention is based on a gyroscope oriented so as to couple the angular kinetic energy of a spinning astronomical body to a load, whereby the energy is extracted from the gyroscope's rotor rotating in accordance with a conical precession axis. The invention is referred to herein as a gyroscopic power generator, a gyroscope power generator, and a generator.

The behavior of gyroscopes is well described in the literature including various websites such as en.wikipedia.org/wiki/Gyroscope, www.integerspin.co.uk/gyrol.htm, www.gyroscopes.org/math2.asp, www.accs.net/users/cefpearson/welcome.htm, www.mariner.connectfree.co.uk/html/gyro.htm, www.freestudy.co.uk/dynamics/gyroscope.pdf, and technical papers including Binder; Bernd, “Magic Angle Chaotic Precession”, CHAOS2008 Conference Greece/Grete/Chania, 13.6, 2008, which are each incorporated herein by reference in their entirety.

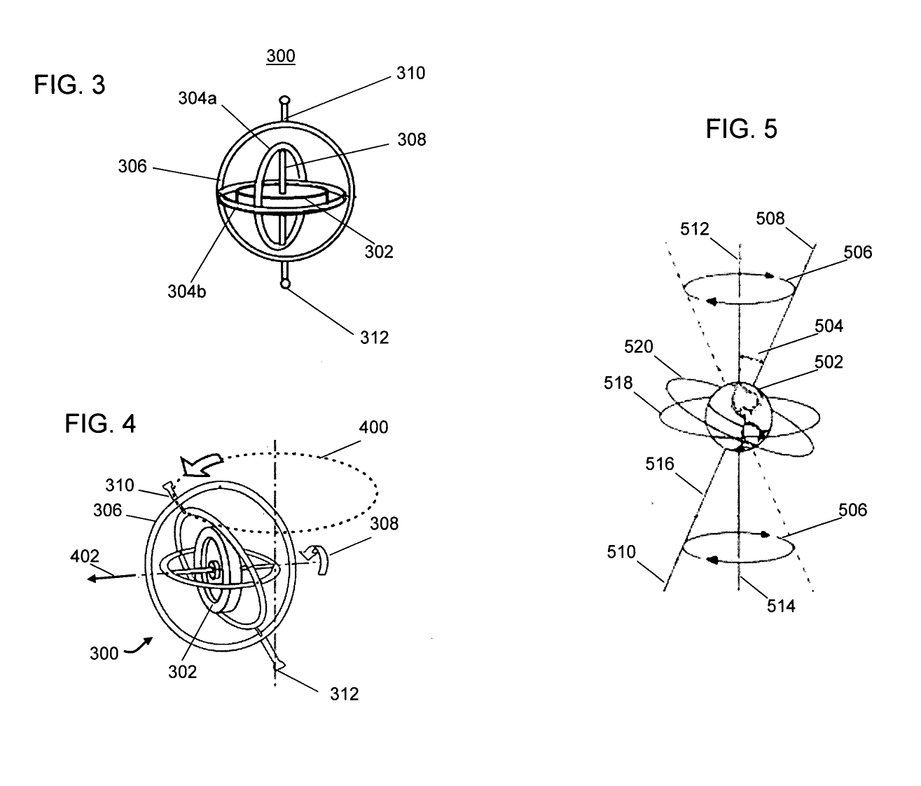

FIG. 3 depicts the components of an exemplary gyroscope. Referring to FIG. 3, an exemplary gyroscope 300 comprises a disc 302, or rotor, a first gimbal 304a, a second gimbal 304b, and a gyroscope frame 306. The rotor 302 spins about a spin axis 308 connected via two pivot points to a first (innermost) gimbal 304a such that the rotor 302 and the first gimbal 304a can spin about the same spin axis 308. The first gimbal 304a is connected to a second gimbal 304b via two pivot points such that the second gimbal 304b can spin about the first gimbal 304a about a second axis that is perpendicular (or orthogonal) to the spin axis 308 of the rotor 302 and the first gimbal 304a. The second gimbal 304b is connected via two pivot points to a gyroscope frame 306, or outermost gimbal, such that the gyroscope frame 306 can spin about the second gimbal 304a about a third axis that is perpendicular (or orthogonal) to the second axis. The gyroscope frame 306 has a top axis point 310 and can also pivot about a stationary pivot point 312. Because the gyroscope 300 has freedom about three axes, the rotor 302 will maintain its spin axis direction regardless of the orientation of the outer frame 306.

The fundamental equation describing the behavior of the gyroscope is:

$$τ = \frac{d L}{d t} = \frac{d ( I ω )}{d t} = I α$$

where the vectors τ and L are, respectively, the torque on the gyroscope and its angular momentum 402, the scalar I is its moment of inertia, the vector ω is its angular velocity, and the vector α is its angular acceleration.

It follows from this that a torque τ applied perpendicular to the axis of rotation 308, and therefore perpendicular to L, results in a rotation about an axis perpendicular to both τ and L. This motion is called precession. The angular velocity of precession Ω_{P} is given by the cross product:

τ=Ω_{P}×L

As the second equation shows, under a constant torque, the gyroscope's speed of precession is inversely proportional to its angular momentum.

FIG. 4 depicts precession 400 of the exemplary gyroscope 300 that occurs when a tilting force is applied to the top axis point 310 of the gyroscope frame 306 while the rotor 302 rotates about the spin axis 308.

Angular kinetic energy (or rotational energy) is the kinetic energy due to the rotation of an object and is part of its total kinetic energy. Looking at rotational energy separately in an object's centre of mass frame, one gets the following dependence on the object's moment of inertia:

$${E}_{rotation} = \frac{1}{2} I {ω}^{2}$$

where

ω is the angular velocity

I is the moment of inertia.

The mechanical work required for/applied during rotation is the torque times the rotation angle. The instantaneous power of an angularly accelerating body is the torque times the angular frequency.

There is a close relationship between the results for linear (or translational) and rotational motion; the formula for the

$${E}_{translational} = \frac{1}{2} {mv}^{2}$$

In the rotating system, the moment of inertia, I, takes the role of the mass, m, and the angular velocity, ω, takes the role of the linear velocity, ν. As an example, let us calculate the rotational kinetic energy of the Earth. As the Earth has a period of about 23.93 hours, it has an angular velocity of 7.29×10⁻⁵ rad·s⁻¹. Assuming that the Earth is perfectly spherical and uniform in mass density, it has a moment of inertia, I=9.72×10³⁷ kg·m². Therefore, it has a rotational kinetic energy of 2.58×10²⁹ J.

FIG. 5 depicts the precession of the Earth 502 resulting from its 23.4° tilt 504. As shown, the Earth 502 travels a precession path 506 that cycles approximately every 26,000 years. The precession path 506 produces a conical shape relative to the pivot point for the Earth (i.e., it's center), which is very similar to the conical shape of the precession path of the gyroscope 300 of FIG. 4 relative to its pivot point 312. Also shown in FIG. 5 are the North Celestrial Pole 508, the South Celestrial Pole 510, the North Elliptical Pole 512, the South Elliptical Pole 514, the Earth's axis 516, the Ecliptic 518, and the Celestrial Equator 520.

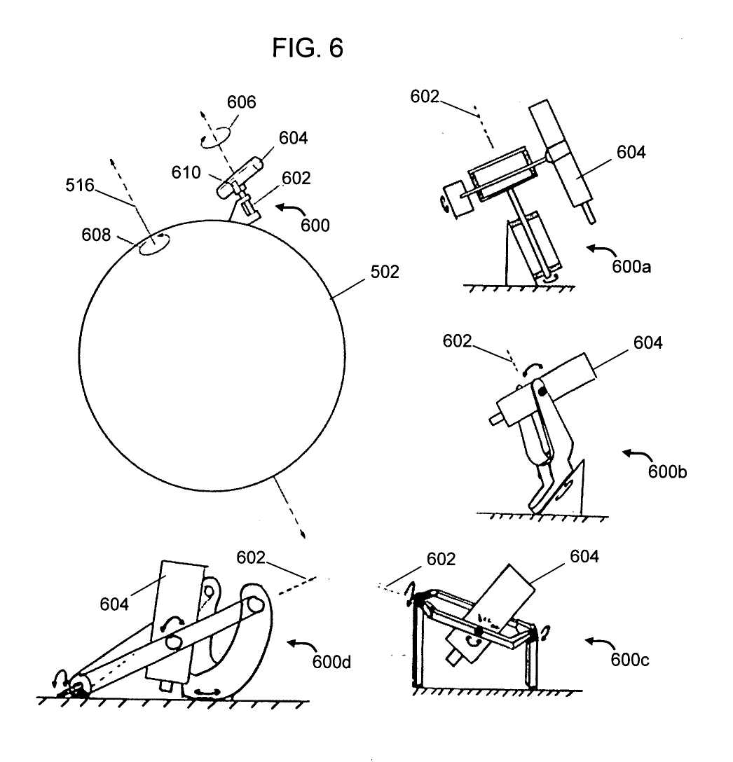

FIG. 6 depicts exemplary equatorial mounts 600. An equatorial mount 600 is a mount that has a first rotational axis 602, or polar axis, that is parallel to the Earth's axis of rotation 516 and a second rotational axis 610, or declination axis, that is perpendicular to the first rotational axis. As shown, the first rotational axis 602 rotates clockwise 606, which is opposite the counterclockwise 608 rotation of the Earth 502. This type of mount is used with telescopes 604, satellite dishes, and cameras. The advantage of an equatorial mount lies in its ability to allow the instrument attached to it to stay fixed on any object in the sky that has a diurnal motion by driving one axis at a constant speed. When used with satellite dishes, an equatorial mount allows the dish to be pointed at several geosynchronous satellites by slewing along one axis. The gyroscopic power generator of the present invention can similarly take advantage of the characteristics of an equatorial mount such that its top axis and spin axis can be positioned relative to the Earth's axis based on its location on the Earth. Also shown in FIG. 6 are several exemplary equatorial mounts including a German equatorial mount 600a, a Fork equatorial mount 600b, a English equatorial mount 600c, and a Horseshoe equatorial mount 600d.

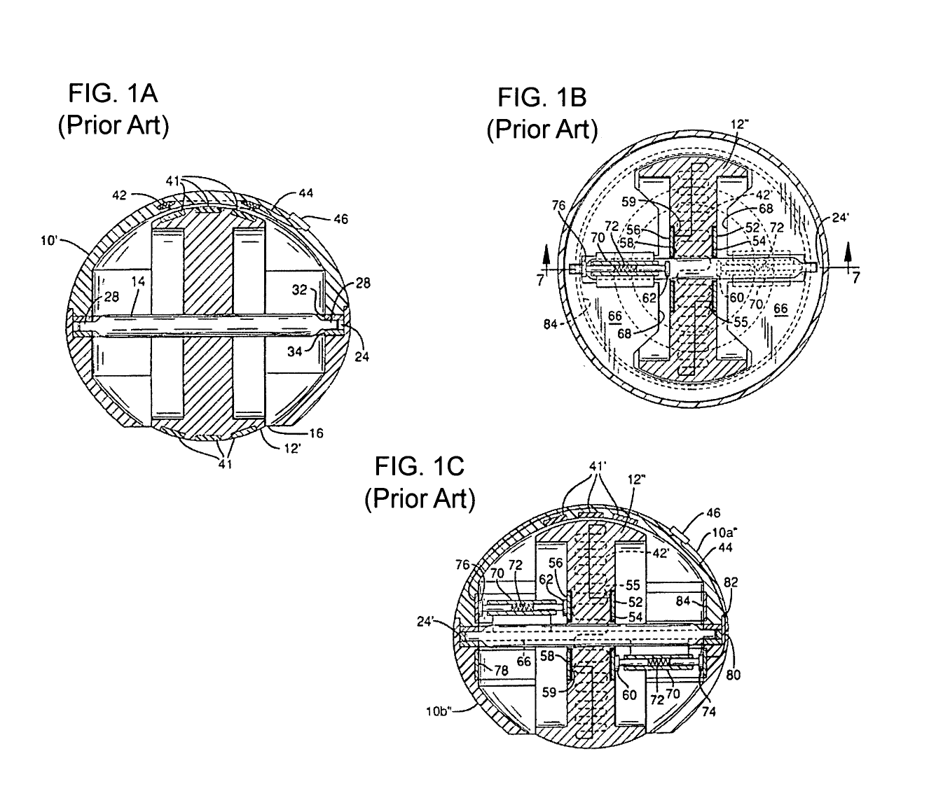

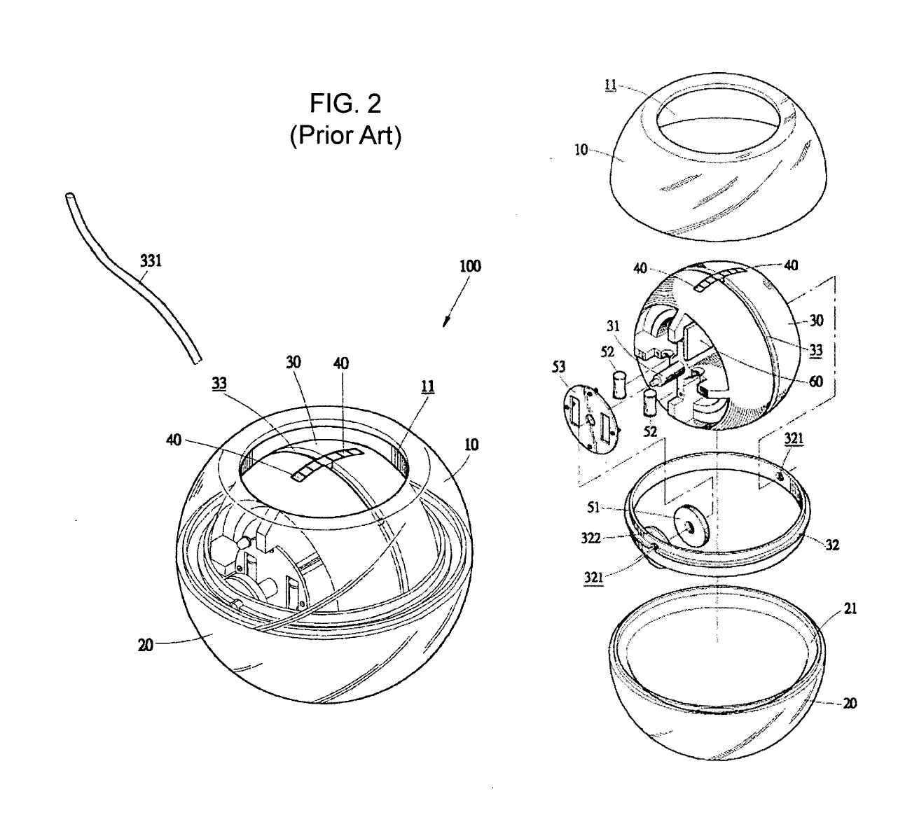

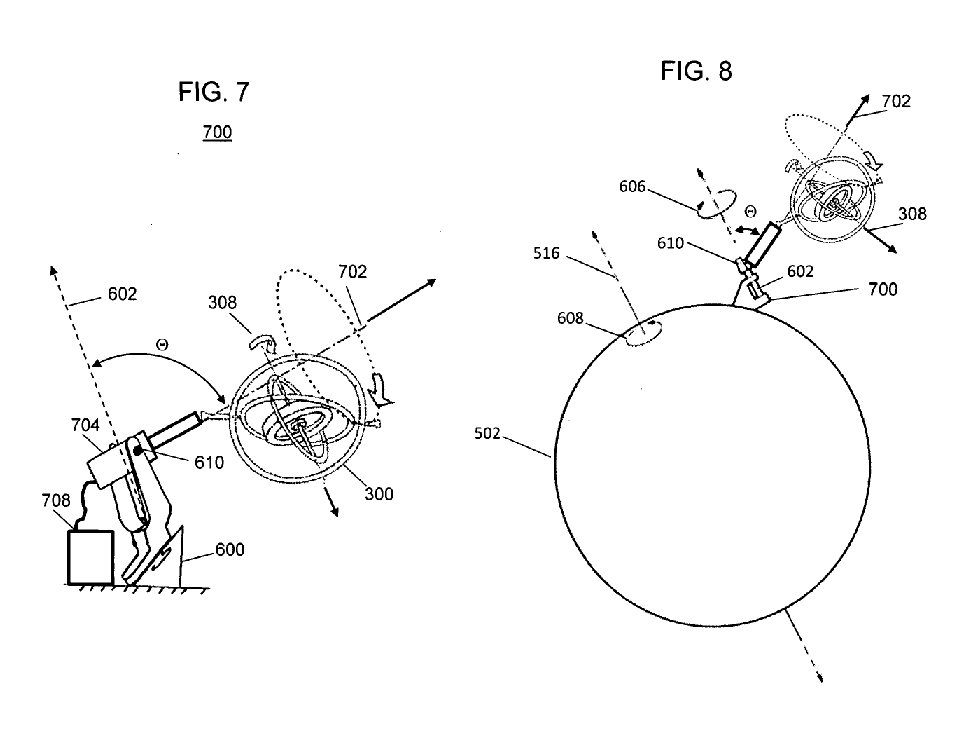

FIG. 7 depicts and exemplary system in accordance with the present invention. As depicted, exemplary gyroscopic power generator system 700 includes an equatorial mount 600 having a first rotational axis 602 positioned relative to the equatorial axis of a spinning body (known as the right ascension), for example the polar axis 516 of the Earth 502, and having a rotational element 704 that can rotate along a second perpendicular axis 610 of motion (known as the declination). The gyroscope 300 of the gyroscopic power generator system 700 is positioned such that it can pivot about a top axis 702 having a desired angle, Θ, relative to the equatorial axis 516 that is determined based on the location (i.e., latitude and elevation) of the system 700 on the spinning body (e.g., Earth 502). Also shown is a power generator/power storage device 708. Although not depicted in FIG. 7, the gyroscope 300 of system 700 would include elements (i.e., coils, magnets, etc.) required to generate power based on the spinning of the rotor 302 of the gyroscope 300. Various approaches for configuring such elements were previously described and depicted in FIGS. 1A, 1B, 1C, and 2 and one skilled in the art would recognize that many different approaches could also be employed in accordance with the present invention.

FIG. 8 depicts an exemplary gyroscopic power generator system 700 having an exemplary configuration based on its location on the Earth 502.

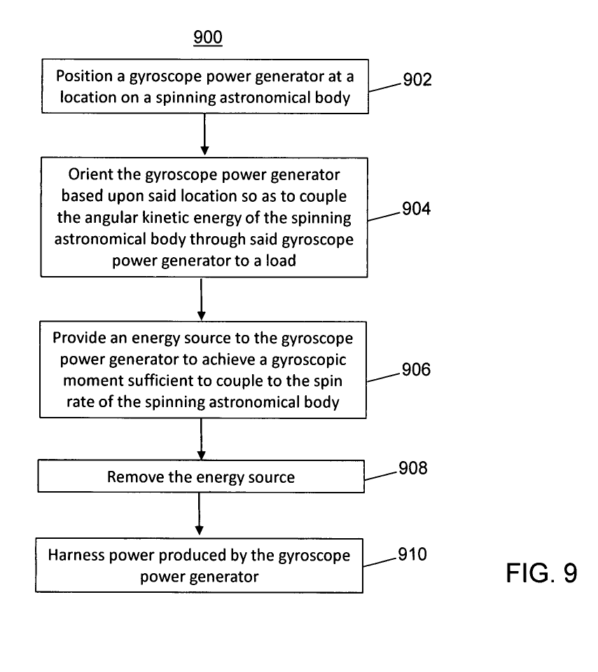

FIG. 9 depicts an exemplary method in accordance with the present invention. Referring to the method of FIG. 9, a first step 902 is to position a gyroscope power generator at a location on a spinning astronomical body. A second step 904 is to orient the gyroscope power generator based upon the location so as to couple the angular kinetic energy of the spinning astronomical body through said gyroscope power generator to a load. A third step 906 of the method 900 is to provide an energy source to the gyroscope power generator to achieve a gyroscopic moment sufficient to couple to the spin rate of the spinning astronomical body. A fourth step 908 is to remove the energy source and a fifth step 910 is to harness power produced by the gyroscope power generator.

The gyroscopic power generator of the present invention can be used to provide power to individual homes and businesses. For example, one or more generators resembling air conditioning units might provide power for a home, where the size of the generators can be scaled in accordance with power needs. Multiple generators can also be used together to provide power to larger areas. Gyroscopic power generators of the present invention can also be used in conjunction with conventional power sources including electrical power sources, gas power sources, hydro power sources, wind power sources, solar power sources, etc. The gyroscopic power generator of the present invention can be used with spinning astronomical bodies to include the Earth, the Earth's moon, other planets, an asteroid, etc. Variations can also be used to provide power to manmade space platforms such as satellites, spacecraft, the Space Station, etc.

While particular embodiments of the invention have been described, it will be understood, however, that the invention is not limited thereto, since modifications may be made by those skilled in the art, particularly in light of the foregoing teachings.

1. A method for generating power using angular kinetic energy, comprising the steps of:
a. positioning a gyroscope power generator at a location on a spinning body;
b. orienting the gyroscope power generator so as to couple the angular kinetic energy of the spinning body through said gyroscope power generator to a load;
c. providing an energy source to the gyroscope power generator to achieve a gyroscopic moment sufficient to couple to the spin rate of the spinning body;
d. removing the energy source; and
e. harnessing power produced by the gyroscope power generator.

2. The method of claim 1, wherein said spinning body is one of a planet, a moon, an asteroid, a satellite, a spacecraft, or a space station.

3. The method of claim 2, wherein said planet is the Earth.

4. The method of claim 1, wherein said orienting is based on the location of the gyroscope power generator on the spinning body.

5. The method of claim 4, wherein said orienting is based on a latitude of the location of the gyroscope power generator.

6. The method of claim 4, wherein said orienting is based on an elevation of the location of the gyroscope power generator.

7. A gyroscope power generator for generating power using angular kinetic energy, comprising:
an equatorial mount comprising:
a first axis positioned relative to an equatorial axis of a spinning body; and
a rotational element that can rotate along a second axis;
a gyroscope positioned to pivot about a top axis having a desired angle relative to the equatorial axis, said gyroscope including a rotor and at least one power generation element to generate power based on the spinning of the rotor; and
a power storage device for storing the power generated by the at least one power generation element.

8. The gyroscope power generator of claim 7, wherein said at least one power generation element includes one of a coil or a magnet.

9. The gyroscope power generator of claim 7, wherein said desired angle is determined based on a location of the gyroscope power generator on the spinning body.

10. The gyroscope power generator of claim 9, wherein said desired angle is based on a latitude of the location of the gyroscope power generator.

11. The gyroscope power generator of claim 9, wherein said desired angle is based on an elevation of the location of the gyroscope power generator.

12. The gyroscope power generator of claim 7, further comprising:
at least one conventional power source.

13. The gyroscope power generator of claim 12, wherein said at least one conventional power source comprises at least one of an electrical power source, a gas power source, a hydro power source, a wind power source, or a solar power source.

14. The gyroscope power generator of claim 7, wherein said equatorial mount comprises one of a German equatorial mount, a Fork equatorial mount, an English equatorial mount, or a Horseshoe equatorial mount.

15. The gyroscope power generator of claim 7, wherein said second axis is perpendicular to said first axis.

16. A method for generating power, comprising the steps of:
a. coupling the angular kinetic energy of a spinning body through a gyroscope power generator to a load;
b. achieving a gyroscopic moment sufficient to couple to the spin rate of the spinning body, said gyroscope power generator and said spinning body generating said power.

17. The method of claim 16, wherein said spinning body is one of a planet, a moon, an asteroid, a satellite, a spacecraft, or a space station.

18. The method of claim 1, wherein said coupling comprises orienting the gyroscope power generator based on a location of the gyroscope power generator on the spinning body.

19. The method of claim 18, wherein said orienting is based on a latitude of the location of the gyroscope power generator.

20. The method of claim 18, wherein said orienting is based on an elevation of the location of the gyroscope power generator.
